(19) United States
(12) Patent Application Publication
(10) Pub. No.: US 2007/0008408 A1
(43) Pub. Date: Jan. 11, 2007

(54) Wide area security system and method

(76) Inventor: Ron Zehavi, Maccabim Reut (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/158,347

(22) Filed: Jun. 22, 2005

(51) Int. Cl. H04N 7/18

(52) U.S. Cl. 348/143

(57) ABSTRACT

A method and system for providing security to large scale sites with large number of people comprising plurality of surveillance sensors, geographical database for the secured site, experts know-how database with plurality of potential scenarios. The system and method according to the invention can handle a large number of inputs, analyze the meaning of the input, prioritize operation, identify threats and produce instructions to the security personnel in response to events taking place in the secured site.

### BACKGROUND OF THE INVENTION

Security for places with large number of people such as transport hubs, highly occupied working places and the like is of high interest to organizations and establishments. The large number of people, the high rate of rotation of many of them in some cases, the difficulty of applying a unified security methodology to a crowd that is hard and even impossible to train for situations requiring security awareness - all these and many other effects create a need for a system and method for planning, applying, controlling and operating an over-all security solution.

Systems known in the art allow for the solutions in which all the information representing an event of interest in an area of interest is presented to a centralized location in which a person in charge, such as a controller, may process the information, extract an estimated evaluation of the upcoming threat and decide on actions that should be taken in response. In other currently known security systems some of the incoming information, such as video streams, may be filtered by computerized means to screen and pass onward to the controller only information embedded in a video stream that contains, for example, a movement being of predefined characteristics. In yet other systems, computerized means may invoke alerts when a detected movement embedded in a video stream matches a predefined pattern of behavior. None of these systems is capable of analyzing future threats before a system has been tailored to a location, identify potential threats after installing it, training the security staff and control the security staff as well as the crowd under threat in real-time. Nowadays systems are not able also to integrate inputs from different sources so as to create a unified display displaying real-time input such as from a video camera, synthetic input such as underground infrastructure received from infrastructure database and the like. Nowadays security systems are as- well unable to fuse information received from different types of sensors and databases so as to create an educated, fused picture to an operator, according to pre-defined scenario and/or policy, such as prioritizing these sources by urgency of the content of that source or by its relevance to the event being handled or by any desired policy.

Nowadays security systems do not provide also orientation cues that may help an operator of the security system in understanding the video picture he or she is viewing during management of a security event, which may turn to be a very complicated and confusing task, as the camera picture may be of an unknown zooming factor and pointing at a place not known to the operator by its view, etc. Finally, nowadays security systems have typically high rate of false alarms and that rate may go even higher as the complexity of the system becomes higher.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a security system describing utilization of logical resources, constructed and functioning according to some embodiments of the present invention;

FIG. 2 is a schematic illustration of security system describing utilization of peripheral resources, according to some embodiments of the present invention;

FIGS. 3A and 3B are a schematic block diagram illustration and a schematic side view illustration of a positioning system respectively according to some embodiments of the present invention.

FIG. 4 is a schematic block diagram illustration of a security system according to some embodiments of the present invention.; and

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. Still further, functionalities referred to herein below as ‘units’ may be implemented as a physical unit comprising substantially hardware components, as a logical unit comprising substantially software, or as any combination thereof.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

It should be understood that the present invention may be used in a variety of applications. Although the present invention is not limited in this respect, the system and method disclosed herein may be used in many security installations such as indoor environment such as shopping center, transportation stations, hotels and the like, outdoor environment such as university campus, stadium, airport or seaport and the like and perimeter line such as boundary of sensitive zone (such as a power plant), a border line, pipeline and the like. It should also be understood that while the present application widely discusses inventive security systems and methods, the principles of which may also be realized and utilized for similar needs, such as safety of people and/or systems and for the protection of viability and survivability of systems, such as communication systems.

Maintaining security, and especially for a large crowd of people, may impose the need to solve several different problems such as what is the nature of the potential threat, whether a threat may be identified in a relatively early stage based on its nature, when shall an allegedly coincidental group of inputs be translated to an evolving threat. In case a threat has been detected what shall be the next developments of which, how should a random crowd be managed to minimize casualties and harms, and the like. Additionally, there is a need to train the security staff to react fast and accurate when a threat is identified.

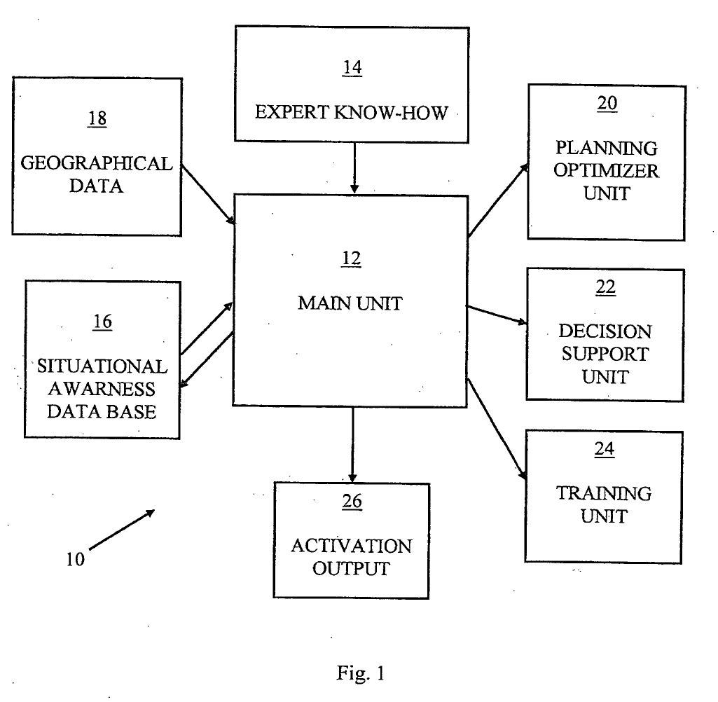

Reference is made now to FIG. 1, which is a schematic illustration of a security system 10 describing utilization of logical resources, constructed and functioning according to the present invention. Security system 10 may comprise a main unit 12, an expert know-how database 14, a situational awareness database 16, a geographical database 18, a planning optimizer unit 20, a decision support unit 22, a training unit 24 and output activation unit 26. Expert know-how database 14 may comprise a large amount of information describing performance of security devices, operational methodology models, security handling policies, and the like. This information may be used as a basis for evaluation of detected events, in order to estimate the threat that they may impose, as well as to administer an on-going threatening event in order to utilize available security resources to minimize the harm that such threat may cause in the most efficient way, and to steer the protected crowed in the most safe way.

Situational awareness database 16 may comprise information describing abnormal behavior, position descriptors of monitored entities, pre-collected intelligence information, data received from security and safety devices, environmental conditions, analysis of expected results of potential threats on the environment (such as the expected damage to a building from the explosion of a given bomb at a given distance from that building) and on persons, and the like. Geographical database 18 may comprise geographical data representing at least an area of interest, such as 2-Dimensional or 3-Dimensional coordinates of a location inside said area of interest. Geographical database 18 may also comprise 3-D description of buildings and infrastructure contained in an area of interest. Planning optimizer unit 20 may comprise information about gaps—known and suspected—in security monitoring coverage, profiles of optimized deployment of security resources and the like. Planning optimizer unit 20 may function to optimize security resources management determined in advance or while a security event is going on. Decision support unit 22 may comprise information on the identification of potential scenarios and may function to recommend of responsive actions that need to be taken in response to a developing security event. Training unit 24 may comprise an updateable bank of scenarios and past events and function to create and monitor training sessions. Activation unit 26 may comprise an appropriate interface supporting the interface to and activation of any auxiliary device, such as indication and guiding lights, summoning means, public address (PA) means, and the like. Such auxiliary device may be used to transmit instructions and/or information to other systems and/or to security staff and/or crowd.

Main unit 12 may comprise a computing unit which is loadable with an appropriate software and equipped with means to perform all functionalities for combining data from the various units and for analyzing the ongoing incoming information in order to detect a developing event of interest, recognize the nature and order of magnitude of a threat it may represent, manage security resources available to it in order to block that recognized threat and to administer the crowd exposed to that threat, as will be explained in details below, by way of examples. Further, main unit 12 may receive information of the progress of a process of response to a threat, such as the evacuation of a crowd form a specific place, and update the operator by displaying that progress to him/her and by invoking updated cues and instructions to the crowd, so as to utilize evacuation passages and means more efficiently and safely. That information of the progress of a response to an event may be collected from sensors utilized by system 10, as will be explained in more details below.

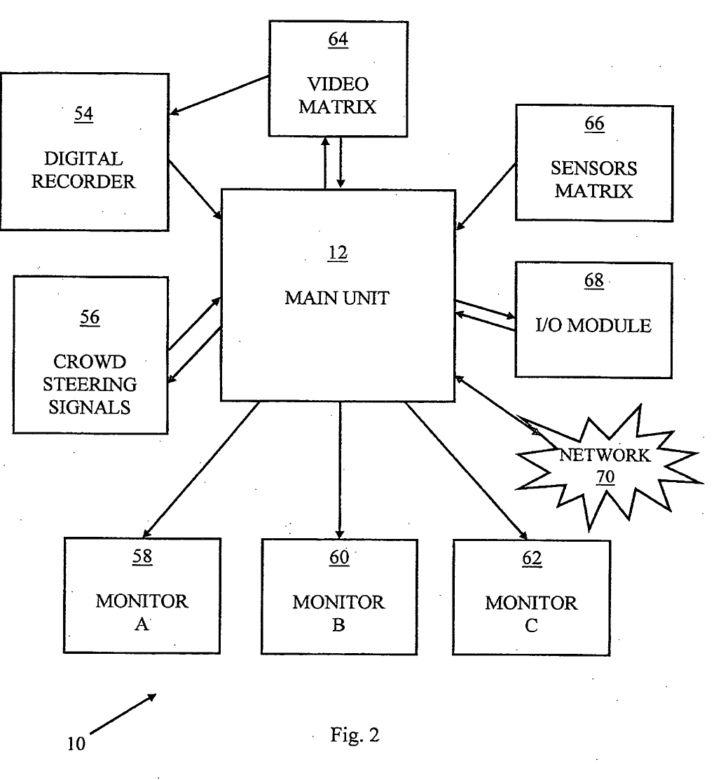

Reference is made now also to FIG. 2, which is a schematic illustration of security system 10 describing utilization of peripheral resources by main unit 12, according to some embodiments of the present invention. As will be explained later, there may certain overlap between units described in connection to FIG. 1 and those described herein forth in connection with FIG. 2. Main unit 12 may be in active connection with video/audio digital recorder 54, with video matrix 64, with sensors matrix 66, with input/output (I/O) module 68, with video/audio monitors 58, 60, 62, with crowd steering signal unit 56 and with network 70. Audio/video digital recorder 54 may be used to save audio/video streams received from system 10, either representing raw data received from the various inputs connected to the system, processed data from the system, logging of events or any combination thereof. Audio/video data stored on digital recorder 54 may be used later for various purposes, such as debriefing of past events and actions, assessment of live input in delay, training, etc. Video matrix 64 may be used to control all audio/video channels utilized by system 10 so as to connect or disconnect each available audio/video source to any available destination, as may be required. Accordingly, video matrix 64 may be connected to digital recorder 54.

Sensors matrix 66 may be used to enable connection of each of the sensors utilized by system 10 (not shown) to any available input channel. Inputs connected to input matrix 66 may be of the discrete type, such as input from a alarm system signaling of the crossing of a defined line, digital or analog input representing a variable which, when its value crosses a pre-defined value, or when the nature of its changes in time according to a pre-defined curve, may represent the occurrence of an event of interest.

I/O module 68 may be used to interface I/O units, such as a keyboard, a pointing device and the like to system 10. Video/audio monitors 58, 60, 62, may be used for various purposes, such as presenting audio/video streams received from various sources in system 10, present analysis of the evolving situation, present suggested actions to be taken by security staff, and the like.

Extraction of 3-D Information Based on Surveillance Camera

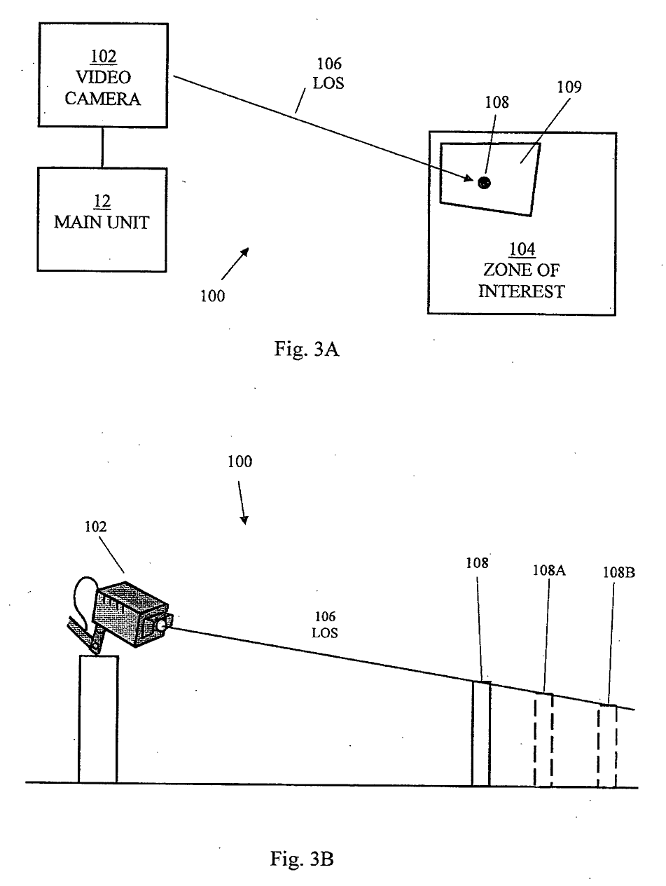

Attention is made now to FIGS. 3A and 3B, which are a schematic block diagram illustration and a schematic side view illustration of a positioning system 100, respectively. Positioning system 100 may comprise at least one video camera 102, which may be connected to main unit 12. Video camera 102 is capable of capturing at least part of zone of interest 104 within its frame so that its line of sight (LOS) 106 points at a point of interest 108 within zone of interest 104. The projection of the captured picture of camera 102 on zone of interest 104 may be defined as the field of view (FOV) 109 of camera 102. Typically point of interest 108 is included in FOV 109. The shape of FOV 109 may vary according to the shape of the frame of camera 102, to the angle of incidence of LOS 106 with the terrain of FOV 109, optical performance and features of camera 102 and according to the terrain covered within its boundaries (some times called also terrain modeling). Video camera 102 may be controlled by main unit 12 so as to point at any desired point within its substantially hemispheric range of coverage. Further, video camera 102 may transmit the coordinates of its LOS to main unit 12.

The 3-D geographical coordinates of video camera 102, as well as its specific performance data (such as zoom range, magnification figure, aspect ratio and the like) may be known from geographical database 18 or from sensor matrix unit 66 or from any other available source of information comprising descriptive data of installed surveillance equipment. LOS 106 may intercept at least one point of interest 108 so that the combination of its planar position data and the height data all calculated from the 3-D specific data of LOS 106 corresponds with the 3-D data of point of interest 108 stored in geographical database 18. In such case the 3-D data of point of interest 108, once calculated, may be stored in main unit 12 for further use. In case a plurality of points 108, 108A and 108B, satisfy the conditions defined above, the coordinates of the point closest to camera 102 will be stored in main unit 12. Alternatively, a line-of-sight analysis may be carried out for all such points that satisfy the conditions above and in order to correctly elect only one of these points as point of interest 108 data from additional sensors, such as another camera 102, placed in a different position and viewing FOV 109, may be used to uniquely solve the correct coordinates of point of interest 108. Accordingly, the 3-D coordinates of any point within the boundaries of FOV 109 may be calculated. Instead of said additional camera 102 which may provide a 2-D location information, there may be used a different sensor. In case said different sensor is a Radar sensor it may provide, typically, a 3-D location information for an investigated entity (typically distance R and spherical angles (φ, φ). Still alternatively, said different sensor may be a line-type sensor (such as a security, monitored, fence or the like) which may provide a 1-D or a 2-D location information if crossed by an intruder. Location information received from such sensor may be used in the manner described above in order to complete missing information of a location of a monitored entity and to remove ambiguity with respect to such location. These coordinates may be used, once calculated, to synchronize additional security resources to that FOV 109, such as directing other directional security resources (like video camera, directional microphone and the like) to point of interest 108 or, if needed, to other points, related to point of interest 108; to direct security personnel to it or to direct the crowd away from it (in case it represents a spot of high risk) and the like.

When geographical database 18 comprises also a 3-D description of buildings and infrastructure contained in an area of interest, this data may further be integrated so as to more accurately calculate the 3-D data of point of interest 108 and more descriptively display such data on a picture of area of interest 104.

Planning and Security Gap Monitoring

For better security performance planning ahead is a key for success. With system 10 built and working according to the present invention planning is made an easier job. Based on the information stored in geographical database 18 and further based on the ability of system 10 to match planar coordinates to a point in the field of view of a camera engaged in system 10, as discussed above, a thorough inspection of the terrain in area of interest 104, including analysis of invisible areas created due to concealment by the terrain itself or by infrastructure entities, such as buildings, my be carried out by system 10. Such analysis may disclose to an operator of system 10 areas which have too low coverage by security means of system 10, thus assisting in planning a better security solution. Same features of system lo may assist in identifying in advance points of weakness of the security envelope provided by system 10 which, if are not curable, may be the weak link through which an intrusion or a threat may be expected.

For improved planning of security system and method according to the present invention an advantage may be further be taken of the system ability to store and simulate scenarios of possible threats. When such scenario is processed and specifically when a scenario is used for training of security personnel, gaps, weak points and malfunctions of the security system are identified and may then be fixed. Situational Awareness

As discussed in brief above, situational awareness database 16 may comprise information describing abnormal behavior, position descriptors of monitored entities, pre-collected intelligence information, data received from security and safety devices, environmental conditions, and the like. While normal behavior may be defined as the behavior that would have been expected from a monitored entity while in a given situation, an abnormal behavior is the complementary one. For example, a man walking along a pavement or a path may be regarded as acting in “normal behavior”. In the same manner a man crossing a garden or a car driving over the lawn may be regarded as acting in an “abnormal behavior”. Behavior of an entity may be deducted from the way it changes over time, for example. Thus, when the monitored entity is a person, his movement, the first derivative of his location expressed by the momentary values of 6 dimensions (3 linear and 3 rotational vectors, for example), may be an example of the representation of “a behavior” of that person. Situational awareness database 16 may comprise definitions and description of abnormal behavior of persons and other entities that may be monitored during the occurrence of an event of interest. These definitions and description may be compared to the actual behavior of a monitored entity in real-time and when an abnormal behavior has been detected main unit 12 may be alerted. The level of deviation of a monitored behavior from the ‘normal’ so that it will be regarded ‘abnormal’ may be defined. Monitoring of the behavior of an entity in a monitored area may rely on known tracking solutions, while the decision on whether the track being performed by the monitored entity along time is within the ‘normal’ boundaries may take the advantage of combining of data describing infrastructure on a camera picture, as described above in details. Additionally, as part of the situational awareness of system built and functioning according embodiments of the present invention, computerized aided entity recognition ability may be supported. Entity recognition may be carried out by cross- linking descriptive information of a monitored entity received from plurality of sensors and additional sources. For example, the 2-D image of said entity as received in a video camera 102 may be compared to a bank of pre-defined entities and to location information received from another sensor. The 2-D shape of that entity may correspond to more than a single entity found in said bank of entities, differing from one another in their sizes but having substantially the same shape. In such case the location information received from said additional sensor may define the distance of the monitored entity from video camera 102 and with this, the right entity from the plurality of entities may be decided.

The combination of identification of abnormal behavior of a monitored entity with its ability to identify it in a bank of entities may not only dramatically improve the ability of system 10, 100 to identify a potential threat while lowering the rate of false alarm. It may also extend the alert time period by allowing a first alarm to be set earlier.

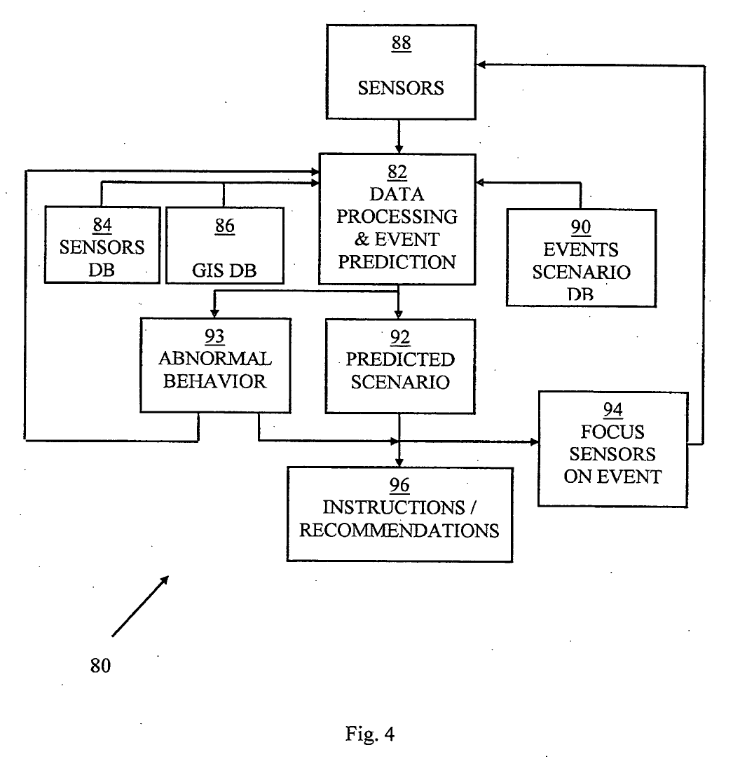

As part of the situational awareness capabilities of a security system according to the present invention, when an abnormal behavior of a monitored entity is detected, additional to a general alarm that may be invoked in the system, an automatic or semi- automatic directions may be transmitted to various security directional sensors, such as video cameras or directional microphones, to focus on that abnormal behavior zone. A reference is made here to FIG. 4, which is a schematic block diagram of a security system 80 according to some embodiments of the present invention. Data received from sensors 88, which may comprise video camera, surveillance microphone, trespassing sensor and the like, is forwarded to data processing and event prediction unit 82. This data may be processed in view of information stored in sensors database 84, geographical information system (GIS) database 86 and in events scenario database 90. Sensors database 84 may store technical and location description of each of the sensors in the security system, so that a signal received from such sensor may be fully appreciated and accurately processed and combined in the system. GIS database 86 may comprise geographical information of the area monitored by the security system according to the present invention, such as terrain information (the elevation of points in that area), description of infrastructure in that area (buildings, roads, pipeline networks and the like), etc. Events scenario database 90 may comprise plurality of pre-developed scenarios forecasting possible future developments in response to a set of present events. Based on information received from sensors 88 and in view of data retrieved from sensors database 84, GIS database 86 and events scenario database 90, data processing and event prediction unit 82 may process the information and decide whether an abnormal behavior has been detected, according to the principles detailed above. In case an abnormal behavior has been detected (block 93) a signal is transmitted to sensors 88 to focus on that event (block 94) in order to improve and enhance its reflection to the system. An additional signal is transmitted to block 96 in order to invoke instructions and to provide recommendations (block 96) to security staff and to protected crowd, as may be required. Additionally, in case an abnormal behavior has been detected, a signal may be transmitted back to data processing and event prediction unit 82 to serve as an updated part of the information that may continuously be processed by this unit.

Additional to the above, situational awareness may be based on positional data of monitored entities received from these entities, directly or calculated by the system of the present invention; on early intelligence collected from various sources and stored in the system and on data representing the environmental conditions of the environment of the monitored system.

Information representing an event of interest, such as a monitored moving entity or an entity defined as having abnormal behavior, may be displayed to an operator of the system together with complementary information—visual, textual, vocal or the like. For example, when an entity having an abnormal behavior has been detected, the real video of this entity, taken from at least one video camera that is focusing on it, may be displayed on the real-video background around it in the frame of the camera. On this picture, as layers of visual information, there may be added information about underground infrastructure of interest, areas of coverage of LOS of additional video cameras in the near vicinity, line of fire of stationary or moving guards which may be taken from a database or reflected from sensors transmitting their actual position, signal next to the monitored entity that may reflect its evaluated momentary direction of movement and/or its calculated potential of causing harm, and the like. These additional informative layers may be displayed as ‘synthetic’ layers (i.e. involving information calculated by the system) on the background of real- time video picture and the system may have the ability to allow an operator to switch each of these layers on or off from display, as may be required. In addition, the system may add textual and vocal information corresponding to the displayed data that may contain complementary information such as instructions regarding the evolving situation and the like.

Decision Support

The system and method according to some embodiments of the present invention may comprise a decision support unit 22 (FIG. 1) which may assist in taking complicated decisions specifically in conditions of an evolving security event. As discussed in brief above, decision support unit 22 may comprise information on the identification of potential scenarios and may function to recommend of responsive actions that need to be taken in response to a developing security event. The scenarios may be received from expert know-how unit 14 (FIG. 1). Such scenario may reflect analysis made in advance by security experts as to the possible meaning or meanings of different combinations of various inputs from sensor matrix 64. The resulting recommendation of decision support unit 22 may be applied automatically, semi- automatically or manually, as per the decision of the personnel in charge of handling that situation. The support given by decision support unit 22 may be uttered in presenting reduced number of possible developments of the situation, reduced number of actions that need to be taken, educated “check-list” of operations that should be activated by the operator, and the like.

Training

A very important part of a well functioning security system, such as that of the present invention, is the training part. A security system is usually known for its high demands both for fast response and for its intolerance to mistakes. In order to improve the functioning of each of the personnel involved in carrying out the policy of security system 10 according to the present invention training unit 24 is comprised in security system 10. Scenarios identified for real-time operation of system 10, as well as imaginary scenarios built on realistic basis may be used for training security personnel in real-like situations. The ability of system 10 to collect and record information from the protected area as well as to record operations taken during handling of previous events may be used during training for debriefing the actual performance of said security personnel in order to improve in a later session of training. Same abilities may be further relied upon in improving the utilization of system 10 and all its sub-modes by the security personnel.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention. It should also be understood that while the present application widely discusses inventive security systems and methods, the principles of which may also be realized and utilized for similar needs, such as safety of people and/or systems and for the protection of viability and survivability of systems, such as communication systems.

What is claimed is:

1. A method comprising:
receiving data describing at least one sensor from a sensors database;
receiving data describing at least one possible scenario from a scenario database;
receiving data describing location information for said at least one sensor from a geographical database;
receiving actual data describing location and movement of at least one monitored entity from at said least one sensor in combination with location information received from said geographical database;
receiving data defining whether a monitored entity is acting in abnormal behavior;
evaluating said received data to define a predicted scenario, and providing, based on that scenario, instructions to aim controllable sensors to said monitored entity in accordance to said predicted scenario and instruction and recommendation to security personnel.

2. The method of claim 1, further comprising, prior to said step of evaluating receiving data from an experts know-how database.

3. The method of claim 1, further comprising, prior to said step of evaluating receiving data from a decision support unit.

4. A system comprising:
a geographical database comprising location information of entities within a defined zone;
a situational awareness database comprising data describing abnormal behavior parameters defined for a plurality of predefined entities observable within said defined zone;
an expert know-how database comprising information describing performance of security devices, operational methodology models and security handling policies, and
a main unit capable of receiving information from said databases, comparing said received data to predefined patterns, identify if a security situation is in progress and to output instructions accordingly.

5. The system of claim 4 further comprising
a planning optimizer unit comprising information about gaps in security monitoring coverage in said zone and profiles of optimized deployment of security resources;
a decision support unit comprising information on the identification of potential scenarios, and
a training unit comprising an updateable bank of scenarios and past events,
wherein said additional units are in active communication with said main unit.

6. A method comprising:
receiving data describing location and direction of aiming of a video camera; receiving data describing terrain elevation of an area, said camera video is aiming to said area,
calculating the 3-D location of at least one point intercepted by a line of sight of said camera and included in said area from said data describing location and direction of aiming of said camera and from said data describing terrain elevation of said area

7. The method of claim 6 further comprising
if more than one point in said terrain matches the results of said calculations, selecting from said more than one point that point which is closest to said camera

8. The method of claim 6 further comprising, prior to said step of calculating
receiving data from at least one additional sensor, monitoring said area, and
comparing data received from said at least one additional sensor with said data received from said video camera to calculate said 3-D location of said at least one point with better accuracy.
